(19) United States
(12) Patent Application Publication
(10) Pub. No.: US 2005/0274363 A1
(43) Pub. Date: Dec. 15, 2005

(54) Fuel return structure of vehicle fuel pump

(75) Inventor: Hideo Amino, Wako-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: HONDA MOTOR CO., LTD., Tokyo (JP)

(21) Appl. No.: 11/137,484

(22) Filed: May 26, 2005

(30) Foreign Application Priority Data
Jun. 15, 2004 (JP) 2004-176789

(51) Int. Cl. F02M 1/00

(52) U.S. Cl. 123/514

(57) ABSTRACT

A fuel return structure of a vehicle fuel pump, for supplying fuel from a fuel tank to a vehicle engine, includes a supply port for supplying fuel to the fuel pump from the fuel tank and a return pipe for returning excess fuel from the fuel pump to the fuel tank. Furthermore, the supply port and the return pipe are disposed on opposing sides of a centerline of the vehicle body.

### FIELD OF THE INVENTION

The present invention relates to an improved fuel return structure of a vehicle fuel pump arranged on a vehicle for returning excessive fuel fed out from a fuel pump to a fuel tank.

### BACKGROUND OF THE INVENTION

Hitherto, there is proposed a fuel return structure of a type which supplies fuel in a fuel tank arranged on a saddle type vehicle such as a motorcycle to an engine via a fuel pump, and returns excessive fuel generated at this time to the fuel tank via a return pipe (for example, see JP-A-11-93794 (FIG. 1)).

FIG. 1 of JP '794 is a cross-sectional view showing a vehicle fuel supply device in the related art, and the fuel supply device is configured by mounting a base plate 34 of a fuel pump subassembly 33 from below to a rear end of a bottom plate 30 of a fuel tank 1 (the reference numerals are quoted from the aforementioned patent publication, hereinafter), mounting a strainer communicated to an inlet port at the lower portion of the fuel pump subassembly 33, disposing a fuel adsorbing member 35 on the strainer, and disposing an exit of a fuel return pipe 10 as a return pipe on the fuel adsorbing member 35.

Returned fuel which is excessive in the fuel pump is directed to the fuel adsorbing member 35 and is discharged from the exit of the fuel return pipe 10.

The fuel adsorbing member 35 is a filter formed like a sponge using a stainless steel coil for adsorbing fuel discharged from the fuel return pipe 10 and, in the course thereof, separating gas and liquid and causing it to accumulate as liquid fuel in the vicinity of a strainer in a state of being adsorbed in the fuel adsorbing member 35.

However, since the fuel adsorbing member 35 is provided on a strainer continued to the inlet port of the fuel pump, the returned fuel containing air bubbles in the return pipe 10 is returned to the proximity of the inlet port.

### SUMMARY OF THE INVENTION

Accordingly, it is an object of the present invention to provide a fuel return structure in which fuel containing air bubbles in the return pipe is returned to a position apart from the fuel pump, so that the influence of air bubbles can be reduced.

A vehicle fuel pump is of a type which supplies fuel in a fuel tank disposed in front of a saddle type seat to an engine by a fuel pump, and returns the excessive amount generated at this time from the fuel pump to the fuel tank using a return pipe inserted into the fuel tank. It is characterized in that a supply port from the fuel tank to the fuel pump and the return pipe are disposed in such a manner that the supply port from the fuel tank is disposed on one of the left or right of the centerline of the vehicle body and the return pipe is disposed on the other side. In other words, the supply port and the return pipe are disposed on opposing sides of a center line of the vehicle body.

Further, the exit of the return pipe may be opened at the upper portion in the interior of the fuel tank. Also, the exit of the return pipe may be opened at a position higher than the maximum fuel level when the fuel tank is full. Additionally, the return pipe may be formed of metal pipe.

Furthermore, the fuel pump may be disposed outside the fuel tank and rearwardly of the fuel tank at the substantially center of the vehicle body.

Accordingly, in the fuel tank, since the supply port to the fuel pump and the return pipe are disposed at a position apart from each other with reference to the centerline of the vehicle body, fuel containing air bubbles returning from the return pipe to the fuel tank returns to a position apart from the supply port to the fuel pump.

By disposing the return pipe in the fuel tank at a position sufficiently apart from the exit of fuel having the supply port to the fuel pump, majority of the air bubbles contained in the fuel returning to the fuel tank moves upward to the fuel surface and disappear.

Consequently, the air bubbles to be mixed into fuel coming through the supply port to the fuel pump are reduced, whereby problems which are caused by the air bubbles getting mixed into the fuel can be advantageously reduced.

Since the exit of the return pipe is shown to be opened in the upper portion in the interior of the fuel tank, the extent of variations in fuel pressure near the exit of the return pipe due to the amount of the fuel in the tank is small.

Since the extent of variations in fuel pressure is small in the vicinity of the exit of the return pipe, variations in load with respect to the fuel pump can be reduced.

Consequently, the discharging capacity of the fuel pump can be advantageously maintained stably.

Also, since the exit of the return pipe may be opened at a position higher than the maximum fuel level when the fuel tank is full, so that fuel in the tank is prevented from leaking even when the fuel pump is removed for maintenance, maintainability can advantageously be improved.

Since the return pipe may be formed of metal pipe which has a higher coefficient of thermal conductivity in comparison with a pipe of other material such as resin, heat of fuel which is warmed up in a fuel path including the fuel pump is removed by the fuel in the tank until it reaches the exit of the return pipe, it can be cooled down.

By cooling down the fuel within the return pipe, the air bubbles contained in the fuel within the return pipe can be reduced.

In accordance with the reduction of the air bubbles contained in the fuel within the return pipe, the quantity of the air bubbles contained in fuel in the fuel tank is also reduced.

Consequently, since the air bubbles which were mixed into the fuel coming through the supply port to the fuel pump are reduced, problems caused by the air bubbles getting mixed into the fuel can be advantageously prevented.

Further, when the fuel pump is disposed outside of the fuel tank and rearwardly of the fuel tank substantially at the center of the vehicle body, piping on the left and right of the fuel tank can be laid easily. In addition, maintainability of the fuel pump is advantageously improved.

### BRIEF DESCRIPTION OF THE DRAWINGS

Embodiments of the present invention will be described hereinafter with reference to the accompanying drawings, wherein:

FIG. 1 is a side view of a saddle type vehicle provided with a fuel return structure according to the present invention;

FIG. 2 is a side view of the principal portion of the present invention;

FIG. 3 is a bottom view of the fuel tank according to the present invention; and

FIG. 4 is an explanatory drawing for explaining the operation of the fuel return structure.

### DETAILED DESCRIPTION OF THE INVENTION

The drawings are to be viewed in the orientation in which reference numerals are seen right side up.

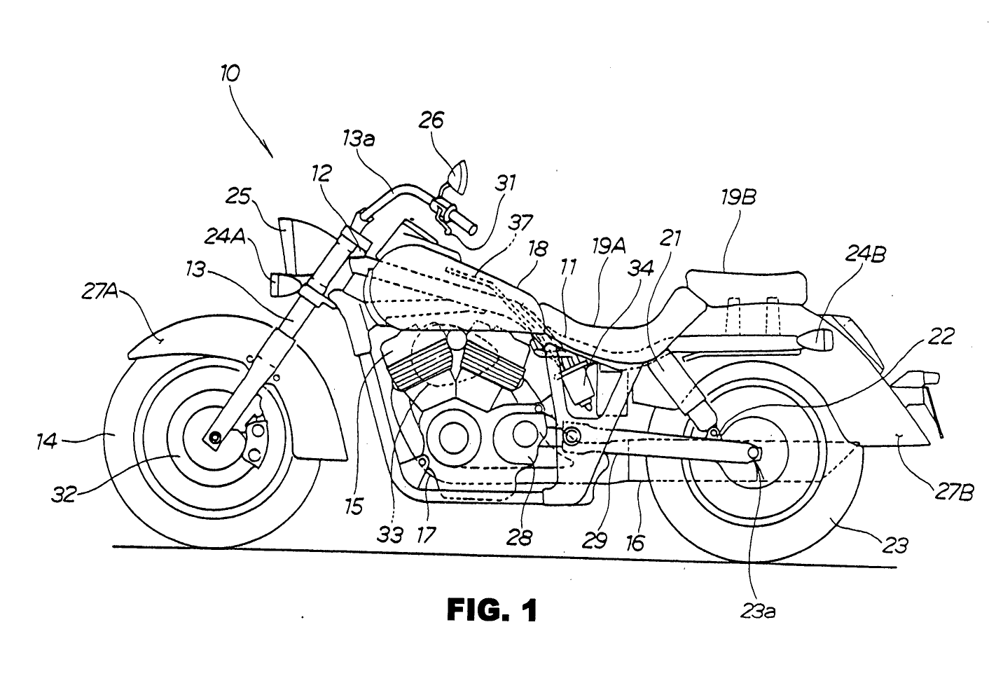

FIG. 1 is a side view of a saddle type vehicle provided with a fuel return structure according to the present invention. A motorcycle 10, which is a sort of the saddle type vehicle includes a main frame 11, a head pipe 12 formed at the front of the main frame 11, front forks 13 steerably mounted via the head pipe 12, a front wheel 14 mounted to the lower part of the front fork 13, an engine 15 suspended from the main frame 11, an exhaust pipe 17 for allowing exhaust gas exhausted by the engine 15 to flow toward a muffler 16, a fuel tank 18 and passenger seats 19A, 19B disposed from the front to the rear of the main frame 11, a swing arm 22 mounted to the rear portion of the main frame 11 so as to be movable in the vertical direction via a rear cushion 21, and a rear wheel 23 mounted to the rear portion of the swing arm 22. Reference numeral 13a designates a handle bar.

Blinkers 24A are mounted so as to project from the left and right front fork 13 leftward and rightward. Reference numeral 25 designates a headlight and reference numeral 26 designates a mirror. A front fender 27A is attached to the inside of the left and right front forks 13. Blinkers 24B are mounted to the left and right of a rear fender 27B.

Describing a drive system, a speed reducer 28 is provided below the engine 15, a drive shaft 29 extends rearward from the speed reducer 28, and an output side of the drive shaft 29 is connected to a shaft 23a of the rear wheel 23.

In this manner, a drive force of the engine 15 is reduced by the speed reducer 28, and is transmitted from the speed reducer 28 to the drive shaft 29, and is transmitted from the output side of the drive shaft 29 to the shaft 23a of the rear wheel 23.

Reference numeral 31 designates a clutch lever, reference numeral 32 designates a disk brake, and reference numeral 33 designates an air filter.

The fuel return structure includes a fuel pump 34 for pumping fuel from the fuel tank 18 to an air-intake system of the engine 15 including the air filter 33 of the engine 15 behind the fuel tank 18 and below the passenger seat 19A, and a return pipe 37 inserted from the fuel pump 34 to the fuel tank 18.

In other words, the motorcycle 10 is the saddle type vehicle, and it can be said that it is a vehicle having such fuel return structure that fuel in the fuel tank 18 disposed in front of the passenger seat 19A which is a sort of the saddle type seat is supplied to the engine 15 by the fuel pump 34, and the excessive fuel which is generated at this time is returned from the fuel pump 34 to the fuel tank 18 using the return pipe 37 inserted into the fuel tank 18. The fuel return structure will be described in detail referring to the next drawing.

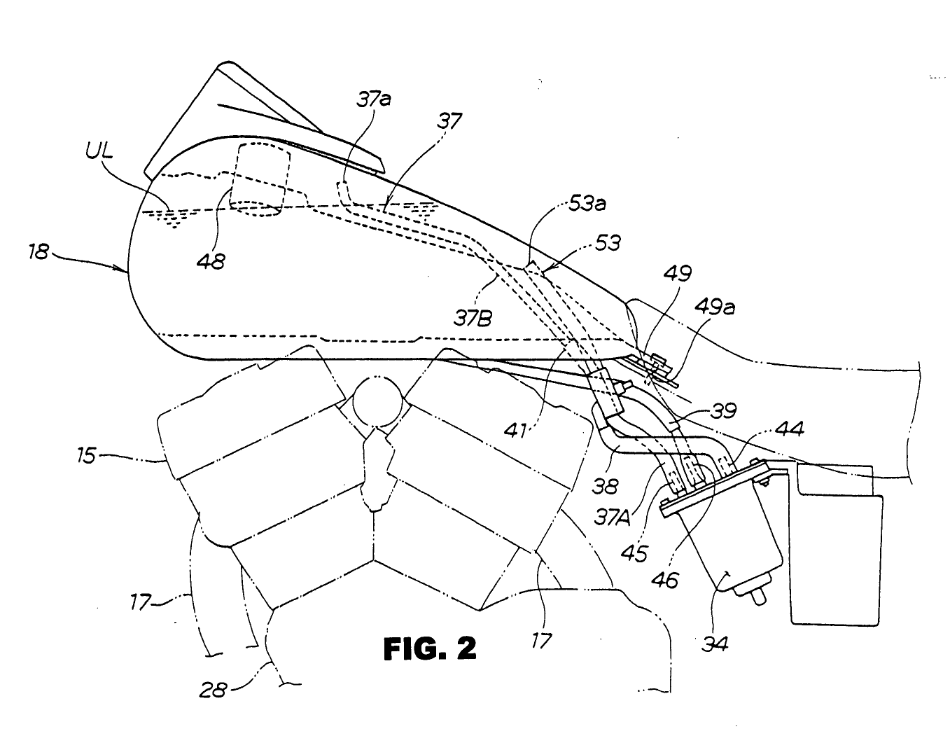

FIG. 2 is a side view of the principal portion of the present invention. Peripheral piping of the fuel pump 34 includes a suction pipe 38 extended between the fuel tank 18 and the fuel pump 34 for allowing fuel to proceed to the fuel pump 34, the return pipe 37 for returning the excessive fuel to the fuel tank 18, and a discharge pipe 39 for pumping fuel from the fuel pump 34 to the air-intake system of the engine 15.

An exit 37a of the return pipe 37 opens at the upper portion in the interior of the fuel tank 18. Since the exit 37a of the return pipe 37 opens at the upper portion in the interior of the fuel tank 18, variations in fuel pressure near the exit 37a of the return pipe due to the amount of fuel in the tank are small.

Since variations in fuel pressure are small in the vicinity of the exit 37a of the return pipe, variations in load with respect to the fuel pump 34 can be reduced. Consequently, the discharging capacity of the fuel pump 34 can be maintained stably.

In addition, the exit 37a of the return pipe is opened at a position higher than the maximum fuel level UL when the fuel tank 18 is full.

Since the exit 37a of the return pipe is opened at a position higher than the maximum fuel level UL when the fuel tank 18 is full, fuel in the fuel tank 18 is prevented from leaking irrespective of the fuel level even when the fuel pump 34 is removed for maintenance. Consequently, the maintainability can be improved.

In addition, the return pipe 37 is formed of metal pipe. Since the return pipe 37 is a metal pipe, it has a higher coefficient of thermal conductivity in comparison with a pipe of other material such as resin. Therefore, heat of fuel which is warmed up in a fuel path including the fuel pump 34 is removed by the fuel in the fuel tank 18 until it reaches the exit 37a of the return pipe, and is cooled down.

By cooling down the returned fuel in the return pipe 37, the amount of the air bubbles contained in the fuel in the return pipe 37, especially, of the air bubbles formed when the fuel is evaporated may be reduced.

In accordance with the reduction of the air bubbles contained in the fuel within the return pipe 37, the quantity of the air bubbles contained in fuel in the fuel tank 18 is also reduced.

Consequently, the amount of the air bubbles contained in the fuel coming out from the fuel exit 53 of the fuel tank 18, which is the supply port to the fuel pump, is reduced significantly, and the probability of the air bubbles contained in the fuel in the return pipe 37 to enter the fuel pump 34 through the strainer and the fuel inlet port is significantly reduced correspondingly.

Furthermore, since the fuel pump 34 is disposed outside of the fuel tank 18 and rearwardly of the fuel tank 18 substantially at the center of the vehicle body, piping on the left and right of the fuel tank 18 can be laid easily. In addition, maintainability of the fuel pump 34 is advantageously improved.

The return pipe 37 includes a first return pipe 37A located outside of the fuel tank 18, and a second return pipe 37B connected to the first return pipe 37A and located inside of the fuel tank 18, and a return member 41 located in the fuel tank 18 is interposed between the first return pipe 37A and the second return pipe 37B.

The fuel pump 34 is a member including an inlet port 44 for connecting the suction pipe 38, a return port 45 for connecting the return pipe 37, and a discharge port 46 for connecting the discharge pipe 39 for pumping the fuel to the air-intake system of the engine 15.

Reference numeral 48 designates a filler member provided at the fuel supply port of the fuel tank 18, and reference numeral 49 designates an extension member extending rearward from the rear end of the fuel tank 18.

Mounting of the fuel tank 18 is achieved by inserting a tightening bolt 51 into a mounting hole 49a opening on the extension member 49 and screwing the same into a member 18a of the main frame side.

In the drawing, reference numeral UL represents the position of the fuel level when the fuel is filled in the fuel tank.

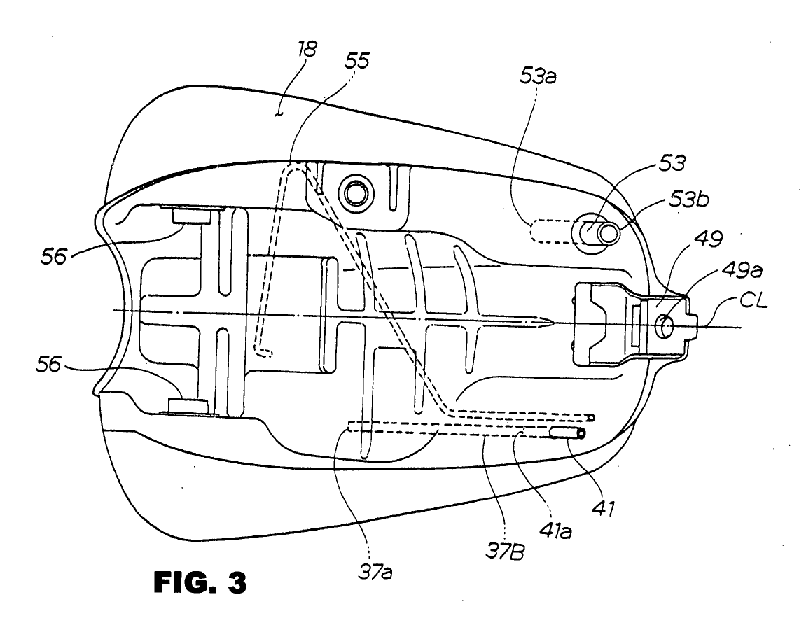

FIG. 3 is a bottom view of the fuel tank according to the present invention. The fuel tank 18 is a member including the fuel exit 53 for outputting the fuel toward the fuel pump, the fuel return member 41 for returning the excessive fuel to the fuel tank 18, and the second return pipe 37B extending inwardly of the fuel tank 18 provided at an other end 41a of the fuel return member 41.

The fuel exit 53 and the fuel return member 41 provided on the fuel tank 18 are arranged in such a manner that the fuel return member 41 provided with the second return pipe 37B is arranged on the right side (lower side in the drawing) and the fuel exit 53 is arranged on the left side (upper side in the drawing) with respect to the centerline CL of the vehicle body. The supply port as an end of the fuel exit 53 is represented by reference numeral 53a.

In other words, the invention is characterized in that the fuel exit 53 having the supply port 53a from the fuel tank 18 to the fuel pump 34, and the return pipe 37 are arranged in such a manner that the fuel exit 53 is arranged on one of the left and the right with respect to the centerline CL of the vehicle body and the return pipe 37 is disposed on the other side thereof.

Reference numeral 55 designates a drain pipe extending from the filler member 48 (see FIG. 2) which is a fuel filling port, to the interior of the fuel tank 18.

Reference numerals 56, 56 are holding members projecting inwardly from the left and right sides of the front portion of the fuel tank 18 for holding on the main frame side, and the fuel tank 18 is mounted to the main frame 11 with the holding members 56, 56 and the extending member 49 provided at the rear end of the fuel tank.

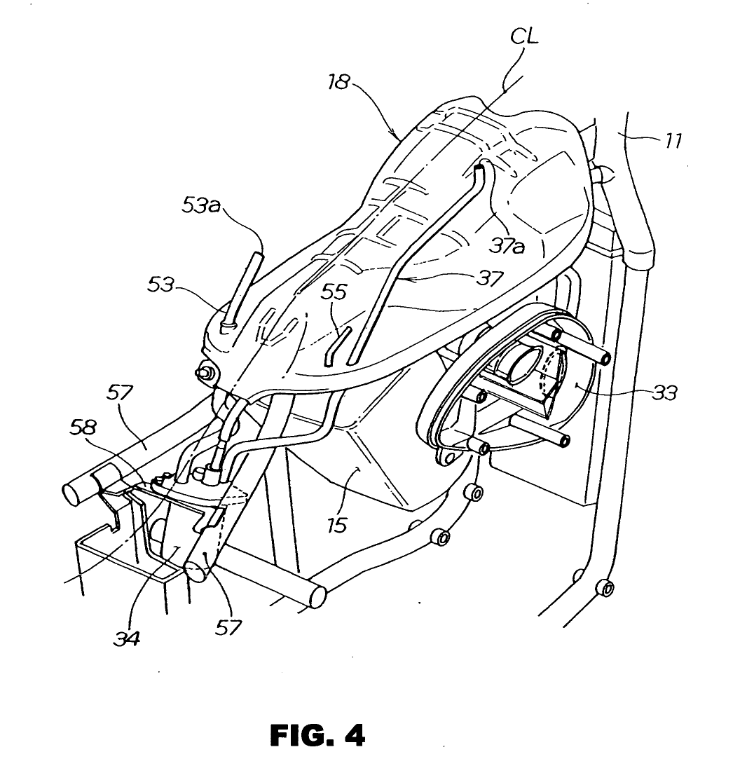

FIG. 4 is an explanatory drawing for explaining the operation of the fuel return structure, in which the side portions and the upper portion of the fuel tank are omitted for explaining the arrangement of the pipe-concerned members.

A bracket 58 is mounted to an upper frame 57, which constitutes part of the main frame 11, and the fuel pump 34 is mounted to the bracket 58.

The operation of the present invention will be described below.

Since the fuel exit 53 having the supply port 53a to the fuel pump 34 and the return pipe 37 are arranged at a position apart from each other with reference to the centerline CL of the vehicle body, the fuel containing the air bubbles which returns from the return pipe 37 to the fuel tank 18 returns to the position apart from the fuel exit 53 having the supply port 53a to the fuel pump.

By disposing the return pipe 37 at a position sufficiently apart from the fuel exit 53 having the supply port 53a to the fuel pump, majority of the air bubbles contained in the fuel returning to the fuel tank 18 move upward to the fuel surface and disappear. Consequently, the air bubbles to be mixed into the fuel coming through the fuel exit 53 having the supply port 53a to the fuel pump are reduced.

Although the exit of the return pipe is opened at the upper portion in the interior of the fuel tank, there is no problem to open the same at the lower portion in the interior of the fuel tank as needed.

The return pipe may not be formed of metal such as steel, aluminum, or copper. For example, it may be formed of resin or rubber.

In addition, although the fuel return structure according to the present invention is suitable for and applied to the motorcycle in the described embodiment, it may also be applied to the other types of vehicles.

Although the embodiment of the present invention has been described in detail, it will be understood that the present invention is not limited to the above-described embodiments, and various modifications in design may be made without departing from the spirit and scope of the invention defined in the claims.

1. A fuel return structure of a vehicle fuel pump, for supplying fuel from a fuel tank to a vehicle engine, said fuel return structure comprising:
a supply port for supplying fuel to the fuel pump from the fuel tank; and
a return pipe for returning excess fuel from the fuel pump to the fuel tank,
wherein said supply port and said return pipe are disposed on opposing sides of a centerline of the vehicle body.

2. The fuel return structure of claim 1, wherein an exit of said return pipe is opened at an upper portion of an interior of the fuel tank.

3. The fuel return structure of claim 1, wherein said return pipe is opened at a position higher than a maximum fuel level when the fuel tank is full.

4. The fuel return structure of claim 1, wherein said return pipe is formed of a metal pipe.

5. The fuel return structure of claim 1, wherein said fuel pump is disposed outside and rearward of the fuel tank at a substantial center of the vehicle body.

6. A fuel return structure of a vehicle fuel pump, for supplying fuel from a fuel tank to a vehicle engine, said fuel return structure comprising:
a supply port for supplying fuel to the fuel pump from the fuel tank; and
a return pipe for returning excess fuel from the fuel pump to the fuel tank, wherein said return pipe is metal and is opened at an upper portion of an interior of the fuel tank, at a position higher than a maximum fuel level when the fuel tank is full, and
wherein said supply port and said return pipe are disposed on opposing sides of a centerline of the vehicle body, and
further wherein the fuel pump is disposed outside and rearward of the fuel tank at a substantial center of the vehicle body.
